(19) United States
(12) Patent Application Publication
(10) Pub. No.: US 2023/0339005 A1
(43) Pub. Date: Oct. 26, 2023

(54) A DECONTAMINATION UNIT, A DECONTAMINATION SET, A DECONTAMINATION ARRANGEMENT AND A METHOD FOR DECONTAMINATING SOIL

(71) Applicant: GLOBE WATER AB, Lidingo (SE)

(72) Inventor: Pontus SCHWALBE, Lidingo (SE)

(73) Assignee: GLOBE WATER AB, Lidingo (SE)

(21) Appl. No.: 17/908,580

(22) PCT Filed: Mar. 11, 2021
(86) PCT No.: PCT/EP2021/056181

§ 371 Date: Sep. 1, 2022

(30) Foreign Application Priority Data
Mar. 12, 2020 (EP) 20162758.5

(51) Int. Cl. B09C 1/08; B09C 1/10

(52) U.S. Cl. CPC B09C 1/08; B09C 1/105; B09C 2101/00

(57) ABSTRACT

A decontamination unit (1) for decontaminating soil of an area (19) of the ground (16) from harmful substances, wherein the decontamination unit (1) comprises: a body (2) comprising an outer coating (3) of a fluid permeable material and an absorbent material (4), for absorbing of the harmful substances, enclosed within the outer coating (3) and a hose (5) having an intermediate perforated part (6) arranged in the absorbent material (4) inside the body (2), and a first end part (7) and a second end part (8) protruding from a respective first end (9) and second end (10) of the body (2), wherein the first end part (9) and the second end part (10) are connectable to another decontamination unit or to a fluid handling device to permit fluid communication to and from the hose (5). A method for decontaminating soil of an area (19) of the ground (16) is also described herein.

### CROSS REFERENCE TO RELATED APPLICATION(S)

This application is a national stage filing of International Application No. PCT/EP2021/056181, filed Mar. 11, 2021, which claims priority to European Patent Application No. 20162758.5, filed on Mar. 12, 2020, which are incorporated by reference as if disclosed herein in their entireties.

### TECHNICAL FIELD

The present disclosure relates to devices and methods for removing of contaminants from the ground.

### BACKGROUND OF THE INVENTION AND PRIOR ART

Worldwide there are large areas with contaminated soil, which soil has been contaminated by harmful substances, such as heavy metals, PCB, chlorinated hydrocarbons, oil, chemicals etc. The contaminated soil prohibits buildings on that ground due to health risks for people that would work and live in the area. The contaminated soil causes also environmental problems which can lead to poisoning of the ground water.

Several methods for cleaning contaminated soil have been developed. Conventionally the contaminated soil is removed and transported to a decontamination facility, in which the soil is cleaned and thereafter restored to the ground area, where the removal took place. Such a method and the decontamination facility become very complicated and thereby expensive to accomplish. The decontamination facility can be a mobile facility to be usable in the areas to be cleaned, or the soil has to be transported to a stationary facility far from the ground area, which requires many heavy transports causing further emissions to the atmosphere. Also chemical methods have been developed to clean contaminated soil, microemulsions then are pressed into the ground to wash the decontaminations away from it. Even this method becomes complicated due to the aggregates pressing down the microemulsions and pumping these again out of the contaminated ground.

Efforts have been made to develop alternative technologies for decontaminating of contaminated soil.

SE507929C2 describes a method and a device for decontaminating soil. According to the document one or several horizontally drilled holes are provided in which a respective chord comprising interlinked sockets with reactive sorbents is inserted. Then, the chord remains under the ground during a sufficiently long period for a desired decontamination of the soil.

Although the method and the device described in the SE507929C2 work well, the handling of the chord at the holes entails some difficulties. Thus, the main object of the present invention is to present a decontamination unit and a method for decontaminating soil that simplifies the process of decontamination of the soil.

### SUMMARY OF THE INVENTION

An object of the present disclosure is to provide an improved decontamination unit that simplifies the process of decontamination of contaminated soil.

The object is achieved by a decontamination unit for decontaminating soil of an area of the ground from harmful substances. With an area is meant a volume of the ground, i.e. the area of the ground has a surface with a surface area and a depth from the surface. The decontamination unit comprises: a body comprising an outer coating of a fluid permeable material and an absorbent material, for absorbing of the harmful substances, enclosed within the outer coating. Thus, the absorbing material is held within the outer coating of the body. The body comprises also a hose having an intermediate perforated part arranged in the absorbent material inside the body, and a first end part and a second end part protruding from a respective first end and second end of the body, wherein the first end part and the second end part are connectable to another decontamination unit or to a fluid handling device to permit fluid communication to and from the hose.

Because the first end part and the second end part of the hose are connectable to another decontamination unit or to a fluid handling device to permit fluid communication to and from the hose, the hose can be connected to another hose of the another decontamination unit or can be connected to the fluid handling device such that the fluid can be supplied to the hose through the another hose or can be supplied directly from the fluid handling device. Further, the fluid can be carried away from the hose through the another hose or directly by means of the fluid handling device.

Thus, one decontamination unit can be connected to the fluid handling device or several decontamination units can be connected to each other forming a line of the decontamination units. The number of the decontamination units connected to each other can be adapted to the area of the ground with the soil to be decontaminated from harmful substances. The decontaminating units can be transported unconnected to the position of the area of the ground and then can be positioned in the ground one by one or can be connected to each other at the position of the area. Thereby, handling of the decontamination units is facilitated which also contributes to simplify the process of decontamination of the contaminated soil.

Consequently, the above mention abject is achieved.

According to one embodiment the decontamination unit comprises a primary connecting member arranged at the first end of the body and a secondary connecting member arranged at the second end of the body, wherein the primary connecting member is connectable to a secondary connecting member of another decontamination unit or to a drawing device to permit drawing of the decontamination unit. Thereby, the decontamination unit can be connected to the another decontamination unit or to the drawing device by means of the connecting members which improves the connection of the decontamination unit with the another decontamination unit or with the drawing device. Thereby risks for disconnection of the decontamination unit from the drawing device can be reduced as well as risks for disconnection of decontamination units, connected to each other, can be reduced.

According to one embodiment the decontamination unit comprises a wire extending through the body and being fastened to the primary connecting member and to the secondary connecting member. The wire, or a rope, improves the strength of the decontamination unit along the extension of the wire. As a result, risks for disconnection of the decontamination unit from the drawing device can be further reduced as well as risks for disconnection of decontamination units, connected to each other, can be further reduced. Further, pulling apart the decontamination unit can be prevented, thanks to the wire.

According to one embodiment the body is an elongated body. Thus, the positioning of the body in, for example a pipe, can be facilitated.

According to one embodiment the absorbent material comprises at least one of bone meal, peat or bark. Bone meal, peat, bark or other natural absorbing materials can effectively absorb harmful substances from the ground in an environment friendly manner. In some cases, the absorbent material may comprise synthetic material such as polypropylene. Further the absorbent material may comprise apatite absorbs cesium.

According to one embodiment the hose is centered in the absorbent material within the body. As a result, fluid supplied to the hose can be evenly distributed around the hose into the absorbent material and further into the soil. The evenly distributed fluid improves the process of decontamination of the decontaminating soil of an area of the ground.

A further object of the present disclosure is to provide an improved decontamination set.

The object is achieved by a decontamination set comprising at least two decontamination units according to any embodiments as above, wherein the at least two decontamination units are connected to each other through at least the first end part or the second end part of the hose. The decontamination set can be assembled at the position for use of the decontamination set. Thus, there is no need of transport a whole set to the position of the area of the ground be de decontaminated. Further, the length of the decontamination set, i.e. the number of decontamination units included in the decontamination set can be decided at the position of the area. Thereby, the process of decontamination of the soil is simplified. Thereby the above mentioned object is achieved.

According to an embodiment at least one of the decontamination units comprises an absorbent material which differs from the absorbent material of the remaining decontamination units. The contaminated soil can be contaminated by different substances located at different positions in the ground. Because the absorbent material differs from the absorbent material of the remaining decontamination units, the absorbent material in the decontamination units can be selected depending on the kind and the position to the contaminations to be catch up by the decontamination units. Thus, an yet improved decontamination set is provided.

A further object of the present disclosure is to provide an improved decontamination arrangement.

The object is achieved by a decontamination arrangement comprising a drain pipe, adapted to be horizontally positioned in the ground, and a decontamination unit according to any of embodiments as above or a decontamination set according to any embodiments as above. As a result, the decontamination arrangement can be assembled at the position of the contaminated soil which simplifies transport of the decontamination arrangement as well as the process of decontaminating the soil.

Thereby the above mentioned object is achieved.

A further object of the present disclosure is to provide an improved method for decontaminating soil.

The object is achieved by a method for decontaminating soil of an area of the ground from harmful substances, the area having a ground surface and a depth from the ground surface into the ground. The method comprises the steps of:
positioning at least one drain pipe, in the area of the ground so that a main part of the at least one drain pipe extends in parallel with the ground surface, wherein the at least one drain pipe has an opening through the ground surface,
inserting a decontamination unit, according to any embodiments of the decontamination unit as above, or a decontamination set, according to any embodiments of the decontamination unit as above, into the at least one drain pipe and
introducing a fluid into the hose to permit the fluid to penetrate the absorbent material and to pass perforations of the drain pipe into the soil of the area of the ground in order to incapacitate the harmful substances.

Because the method uses an improved decontamination unit or an improved decontamination set, an improved method for decontaminating soil of an area of the ground from harmful substances is provided. Thereby the above mentioned object is achieved.

According to one embodiment the step of inserting of the decontamination unit or of the decontamination set into the drain pipe comprises drawing the decontamination unit or the decontamination set into the drain pipe. The decontamination unit or the decontamination set can be drawn into the drain pipe by hand, of a user, or by means of for example a winch.

According to one embodiment the step of introducing of the fluid into the hose comprises heating of the fluid. Thus, the fluid can be hot water, steam or other heated fluids. Heated fluid facilitates distribution of the fluid into the ground as well as improves release of harmful substances from the ground which can improve decontamination of the harmful substances.

According to one embodiment the method comprises the steps of:
investigating the area of the ground to create a mapping of the area, with regard to at least the location of the harmful substances, before the positioning step and then
positioning the least one drain pipe in the area based on the mapping of the area.

According to one embodiment the method comprises the further step of extracting of the fluid from the hose a predetermined time after the introducing of the fluid into the hose. After introduction of the fluid into the hose, the fluid need to act on the ground in order to release harmful substances from the ground and to catch the substances. Thus after the predetermined time after the introducing of the fluid into the hose, the fluid with the harmful substances can be extracted from the hose for further processing, such as cleaning.

According to one embodiment the fluid comprises at least one of a bacteria, fungi, an oxidation medium and a pH-regulating medium. Bacteria, fungi, the oxidation medium and/or the pH-regulating medium can react with harmful substances in the ground, which can improve the decontamination of the ground from harmful substances.

Further advantages as well as advantageous features of the disclosure will appear from the description following below.

### BRIEF DESCRIPTION OF THE DRAWINGS

In the following preferred embodiments of the invention are described with reference to the attached drawings, on which:

FIG. 1a is a cross section of a decontamination unit,

FIG. 1b is a cross section of a decontamination unit comprising a wire,

FIG. 2 is a cross section of a decontamination set and

FIG. 3 is a schematic illustration of a decontamination arrangement positioned in the ground.

### DETAILED DESCRIPTION OF PREFERRED EMBODIMENTS OF THE INVENTION

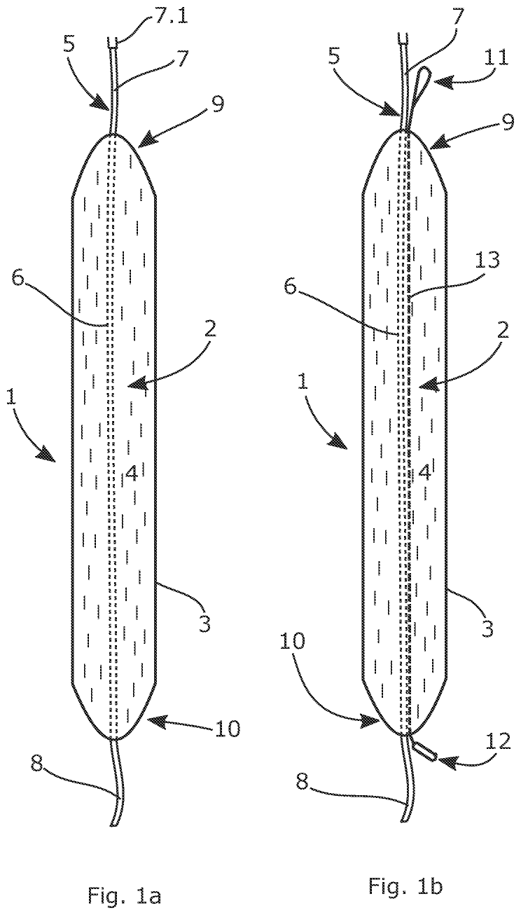

FIGS. 1a and 1b show a decontamination unit 1 for decontaminating soil of an area of the ground from harmful substances. The decontamination unit 1 comprises a body 2 comprising an outer coating 3 of a fluid permeable material, for example ground cloth, and an absorbent material 4, for absorbing of the harmful substances, enclosed within the outer coating 3. According to one embodiment the absorbent material 4 comprises at least one of bone meal, peat or bark.

Further, the decontamination unit 1 comprises a hose 5 having an intermediate perforated part 6 arranged in the absorbent material 4 inside the body 2, and a first end part 7 and a second end part 8 protruding from a respective first end 9 and second end 10 of the body 2. The first end part 7 and the second end part 8 are connectable to another decontamination unit or to a fluid handling device, such as a pump, to permit fluid communication to and from the hose 5.

According to one embodiment the first end part 7 is adapted to receive the second end part 8 of another decontamination unit. For instance, the second end part 8 can be tightly inserted into the first end part 7 to permit fluid communication to and from the hose 5. As illustrated in FIG. 1a and FIG. 1b the first end part 7 has an outer portion 7.1 having diameter that is larger than the diameter of the remaining portion of the first end part 7. Thereby, the second end part 8 can be inserted into the outer portion 7.1 forming a tight connection between the first end part 7 and the second end part 8.

The diameter of the outer portion 7.1 can be adapted such that the connection between the first end part 7 and the second end part 8 enables drawing of the decontamination units 1 connected to each other only through the first part 7 and the second part 8 of the hoses 5. This means that the connection between the outer portion 7.1 and the second part 8 is tight such that friction forces between the outer portion 7.1 and the second part 8 can withstand resistance forces caused mostly due to the weight of the decontamination units 1 during drawing of the decontamination units without separation of the decontaminating units 1.

According to one embodiment the first end part 7 and the second end part 8 are connected to each other by means of a coupling member (not shown) arranged to connect the first end part 7 and the second end part 8 by, for example, tight insertion of the first end part 7 and the second end part 8 into the unit. The coupling member can be arranged in a similar way to a water hose connection available on the market.

As illustrated in FIG. 1b, the decontamination unit 1 comprises a primary connecting member 11 arranged at the first end 9 of the body 2 and a secondary connecting member 12 arranged at the second end 10 of the body 2, wherein the primary connecting member 11 is connectable to a secondary connecting member 12 of another decontamination unit 1 or to a drawing device, such as a winch, to permit drawing of the decontamination unit 1. According to one embodiment the primary connecting member 11 is a loop of a steel wire and the secondary connecting member 12 comprises a carabiner. The loop and the carabiner can be attached to the first end 9 of the body 2 and to the second end 10 of the body 2 respectively by being fastened to the outer coating 3.

As illustrated in FIG. 1b, the decontamination unit 1 can comprise a wire 13 extending through the body 2 and being fastened to the primary connecting member 11 and to the secondary connecting member 12. According to one embodiment the primary connecting member 11, such as a loop, is formed by the wire 13. The secondary connecting member 12, such as a carabiner, can be fastened to the wire 13 by means of a further loop of the wire 13, wherein a part of the carabiner is arranged inside the further loop of the wire 13.

According to the embodiments illustrated in FIG. 1a and FIG. 1b the body 2 is an elongated body 2.

The hose 5 can be centered in the absorbent material 4 within the body 2.

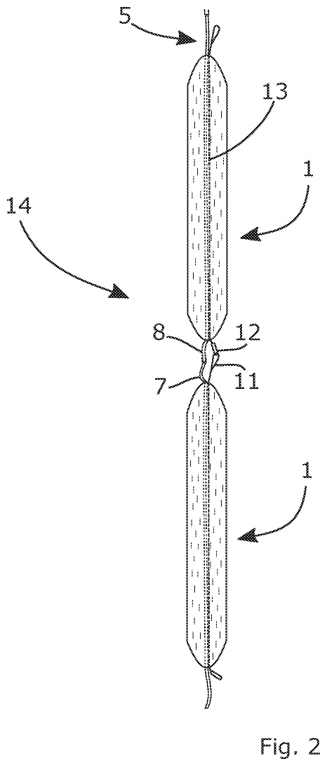

FIG. 2 shows a decontamination set 14 comprising two decontamination units 1 illustrated in FIG. 1b. Thus, the FIG. 2 shows a decontamination set 14 comprising two decontamination units 1 with a wire 13. However, the decontamination set 14 may comprise at least two decontamination units 1 illustrated in FIG. 1a. Because the decontamination unit 1 in FIG. 1a does not comprise a wire, the decontamination units 1 would be connected by means of the hose 5 to build a decontamination set 14. More than two decontamination units 1 can be included in a decontamination set 14.

As illustrated in FIG. 2 the decontamination units 1 have been connected to each other through a first end part 7 and a second end part 8 of respective hose 5 of respective decontamination unit 1 and by the primary connecting member 11 and the secondary connecting member 12 of respective decontamination unit 1. However, according to one embodiment the at least two decontamination units 1 are connected to each other through only the first end part 7 and the second end part 8 of the hose 5.

According to one embodiment at least one of the decontamination units 1 comprises an absorbent material which differs from the absorbent material of the remaining decontamination units 1.

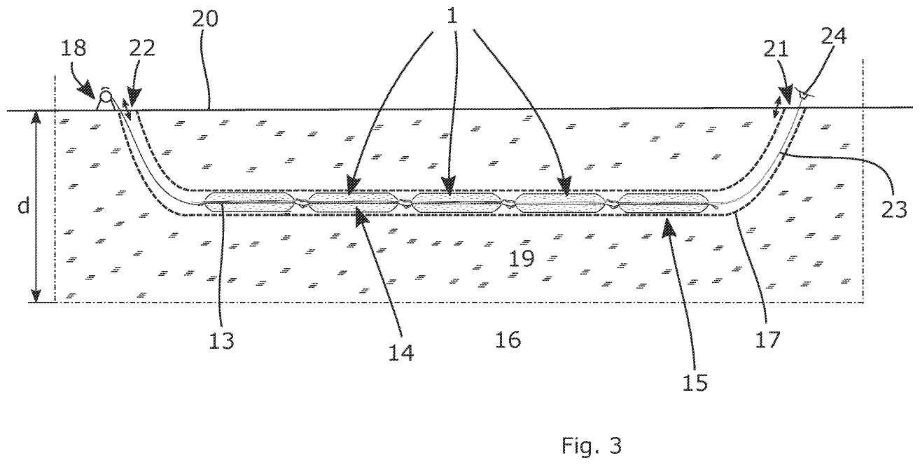

FIG. 3 is a schematic illustration of a decontamination arrangement 15 positioned in the ground 16. According to the embodiment illustrated in FIG. 3, the decontamination arrangement 15 comprises a drain pipe 17, adapted to be horizontally positioned in the ground 16, and a decontamination set 14 comprising several decontamination units 1 connected to each other. The decontamination set 14 can comprise a different number of decontamination units 1, for example one decontamination unit 1 according to FIG. 1b, i.e. with a wire. According to one embodiment the decontamination set 14 comprising a number of connected decontamination units 1, according to FIG. 1a, i.e. without a wire, can be positioned in the drain pipe 17.

An area 19 of the ground 16 can be decontaminated using a method for decontaminating soil of the area 19 of the ground 16 from harmful substances.

The area 19 has a ground surface 20 and a depth d from the ground surface 20 into the ground 16. Thus, with area 19 is meant a volume of the ground 16. The method comprises the steps of:
positioning at least one drain pipe 17, in the area 19 of the ground 16 so that a main part of the at least one drain pipe 17 extends in parallel with the ground surface 20, wherein the at least one drain pipe 17 has an opening 21 through the ground surface 20,
inserting a decontamination unit 1 or a decontamination set 14, described in conjunction to FIG. 2, into the at least one drain pipe 17 and
introducing a fluid into the hose 5 to permit the fluid to penetrate the absorbent material and to pass perforations of the drain pipe into the soil of the area 19 of the ground in order to incapacitate said harmful substances.

As illustrated in FIG. 3, the drain pipe 17 has been positioned in the area 19 of the ground 16 such that the opening 21 extends through the ground surface 20. Thus, the decontamination set 14 with decontamination units 1 can be simply inserted into the drain pipe 17 from the surface 20 of the ground 16 through the opening 21, which may also be called an insertion opening 21. On the opposite side of the drain pipe 17 to the insertion opening 21, there is another opening 22 of the drain pipe 17 extending through the surface 20. The another opening 22 may be called an extraction opening 22 for drawing of the decontamination set 14 in order to position of the decontamination set 14 in an operation position within the drain pipe 17. A winch 18 can be arranged at the extraction opening 22 for drawing of the decontamination set 14 through the drain pipe 17.

According to one embodiment, the hose 5 of the decontamination unit 1b is connected to an extension hose 23 connected to a fluid handling device 24, such as a pump. Thus, a fluid can be delivered to the hose 5 and further to the area 19 of the ground 16.

Several drain pipes 17 can be positioned in the area 19 substantially parallel to each other. The several drain pipes 17 can be positioned on different depths of the area 19, i.e. at different distances from the surface 20. Further, the several drain pipes 17 can be positioned parallel to each other and to the surface 20 and being positioned along an extension of the surface 20.

According to one embodiment the step of inserting of the decontamination unit 1 or of the decontamination set 14 into the drain pipe 17 comprises drawing the decontamination unit 1 or the decontamination set into the drain pipe 17. The drawing can be done by hand of a user or by means of a winch 18.

According to one embodiment the step of introducing of the fluid into the hose 5 comprises heating of the fluid. Thus, the fluid can be hot water, steam or other heated fluids. Heated fluid facilitates distribution of the fluid into the ground 16 as well as improves release of harmful substances from the ground 16 which can improve decontamination of the harmful substances.

Further, the method may comprise the steps of:
investigating the area 19 of the ground 16 to create a mapping of the area 19, with regard to at least the location of the harmful substances, before the positioning step and then
positioning the least one drain pipe 17 in the area 19 of the ground 16 based on the mapping of the area 19.

The mapping may be a 3-D pattern of the area 19, which pattern may be illustrated for a user on a screen.

According to one embodiment the method comprises the further step of extracting of the fluid from the hose 5 a predetermined time after the introducing of the fluid into the hose 5.

The fluid comprises at least one of a bacteria, fungi, an oxidation medium and a pH-regulating medium. Bacteria, fungi, the oxidation medium and/or the pH-regulating medium can react with harmful substances in the ground, which can improve decontamination of the ground from harmful substances.

The bacteria may comprise at least one of Alcanivorax borkumensis, Oleispera, Thalassolitiuus oleivorans, Colwellia and Brachybacterium strain.

The fungi may comprise at least one of Aspergillus niger, Irpex lacteus, Pleurotus ostreatus, White-rot fungi and Ectomycorrhizal fungi.

The pH-regulating medium may be an acid or a base.

It will be understood that the foregoing is illustrative of various embodiments and that the invention is defined only by the appended claims. A person skilled in the art will realize that the embodiments may be modified, and that different features of the embodiments may be combined to create embodiments other than those described herein, without departing from the scope of the present invention, as defined by the appended claims.

As used herein, the term “comprising” or “comprises” is open-ended, and includes one or more stated features, elements, steps, components or functions but does not preclude the presence or addition of one or more other features, elements, steps, components, functions, or groups thereof.

What is claimed is:

1. A decontamination unit for decontaminating soil of an area of the ground from harmful substances, wherein the decontamination unit comprises:
a body comprising an outer coating of a fluid permeable material and an absorbent material, for absorbing of said harmful substances, enclosed within said outer coating and
a hose having an intermediate perforated part arranged in the absorbent material inside the body, and a first end part and a second end part protruding from a respective first end and second end of the body, wherein the first end part and the second end part are connectable to another decontamination unit or to a fluid handling device to permit fluid communication to and from said hose.

2. The decontamination unit according to claim 1, comprising a primary connecting member at the first end of the body and a secondary connecting member arranged at the second end of the body, wherein the primary connecting member is connectable to a secondary connecting member of another decontamination unit or to a drawing device to permit drawing of the decontamination unit.

3. The decontamination unit according to claim 2, comprising a wire extending through the body and being fastened to the primary connecting member and to the secondary connecting member.

4. The decontamination unit according to claim 3, wherein said body is an elongated body.

5. The decontamination unit according to claim 4 wherein said absorbent material comprises at least one of bone meal, peat or bark.

6. The decontamination unit according to claim 5, wherein the hose (5) is centered in the absorbent material within the body (2).

7. A decontamination set comprising at least two decontamination units according to claim 1, wherein the at least two decontamination units (1) are connected to each other through at least the first end part (7) or the second end part (8) of the hose (5).

8. The decontamination set according to claim 7, wherein at least one of the decontamination units comprises an absorbent material which differs from the absorbent material of the remaining decontamination units.

9. A decontamination arrangement comprising a drain pipe, adapted to be horizontally positioned in the ground, and a decontamination unit according to claim 1 or a decontamination set according to claim 7 positioned in the drain pipe.

10. A method for decontaminating soil of an area of the ground from harmful substances, the area having a ground surface and a depth (d) from the ground surface into the ground, the method comprises the steps of:
positioning at least one drain pipe, in the area of the ground so that a main part of the at least one drain pipe extends in parallel with the ground surface, wherein the at least one drain pipe has an opening through the ground surface,
inserting a decontamination unit according to claim 1 or a decontamination set according to claim 7 into the at least one drain pipe and
introducing a fluid into the hose to permit the fluid to penetrate the absorbent material and to pass perforations of the drain pipe into the soil of the area of the ground in order to incapacitate said harmful substances.

11. The method according to claim 10, wherein the step of inserting of the decontamination unit or of the decontamination set into the drain pipe comprises drawing the decontamination unit or the decontamination set into the drain pipe.

12. The method according to claim 11, wherein the step of introducing of the fluid into the hose comprises heating of the fluid.

13. The method according to any of claims 12, comprising the steps of:
investigating the area of the ground to create a mapping of the area, with regard to at least the location of the harmful substances, before the positioning step and then
positioning the least one drain pipe in the area based on the mapping of said area.

14. The method according to any of claim 13, comprising the further step of extracting of the fluid from the hose a predetermined time after the introducing of the fluid into the hose.

15. The method according to any of claim 14, wherein said fluid comprises at least one of a bacteria, fungi, an oxidation medium and a pH-regulating medium.
